(19) United States
(12) Patent Application Publication
(10) Pub. No.: US 2018/0370049 A1
(43) Pub. Date: Dec. 27, 2018

(54) ROBOT ARM MECHANISM

(71) Applicant: LIFE ROBOTICS INC., Tokyo (JP)

(72) Inventors: Woo-Keun YOON, Tokyo (JP); Hiroaki Matsuda, Tokyo (JP)

(21) Appl. No.: 16/047,807

(22) Filed: Jul. 27, 2018

Related U.S. Application Data
(63) Continuation of application No. PCT/JP2017/002231, filed on Jan. 24, 2017.

(30) Foreign Application Priority Data
Jan. 30, 2016 (JP) 2016-016759

(51) Int. Cl. B25J 19/06; B25J 9/04; B25J 9/10; B25J 18/04

(52) U.S. Cl. CPC B25J 19/06; B25J 9/045; B25J 9/102; B25J 18/04; B25J 9/101

(57) ABSTRACT

In a robot arm mechanism, a column equipped with a turning joint is supported on a base stand, a rise/fall section equipped with a rise/fall joint is placed on the column, a linear extension and retraction mechanism equipped with a linearly extendible and retractable arm is provided on the rise/fall section, and the arm is equipped at a tip with a wrist section fittable with an end effector. The wrist section is made up of a combination of a roll joint used to swing the end effector, a pitch joint used to tilt the end effector back and forth, and a yaw joint used to axially rotate the end effector. At least two of the joints are each equipped with a mechanical stopper mechanism adapted to limit motion to within a mechanical operating range and with a safety stopper mechanism adapted to limit motion to within a safe range of movement narrower than the mechanical operating range.

### CROSS-REFERENCE TO RELATED APPLICATIONS

This application is a continuation application of International Patent Application No. PCT/JP2017/002231 filed on Jan. 24, 2017, which is based upon and claims the benefit of priority from the prior Japanese Patent Application No. 2016-016759, filed Jan. 30, 2016 the entire contents of which are incorporated herein by reference.

### FIELD

An embodiment of the present invention relates to a robot arm mechanism.

### BACKGROUND

In recent years, the possibility of a situation in which an industrial robot, not to mention a nursing care robot, works in the vicinity of an operator has been studied. If such a situation is realized, handicapped persons can work similarly, for example, to non-handicapped persons. A vertical articulated robot arm mechanism equipped with a linear extension and retraction joint put to practical use by the inventors has neither an elbow joint nor a singularity, and thus implements an environment in which a robot system works in collaboration with an operator. Naturally, a highly reliable safety level is required for a robot installed in the vicinity of an operator and intended to collaborate with the operator in this way.

It is common practice to limit a range of movement using a soft limit, but from the perspective of ensuring safety reliability, it is necessary to surround the robot with a safety fence in order to provide against setting errors made by the operator as well as emergency situations such as a system runaway or origin displacement.

However, surrounding the robot with a safety fence might lower working efficiency when the robot works in collaboration with the operator. Also, in a situation in which the robot is moved and caused to carry out different collaborative tasks, it is necessary to re-install the safety fence each time, increasing not only downtime, but also workloads, which is very troublesome.

### SUMMARY OF INVENTION

A purpose of the present invention is to provide a robot arm mechanism having high safety reliability.

According to an embodiment of the present invention, there is provided a robot arm mechanism, in which a column equipped with a turning joint is supported on a base stand, a rise/fall section equipped with a rise/fall joint is placed on the column, a linear extension and retraction mechanism equipped with a linearly extendible and retractable arm is provided on the rise/fall section, and the arm is equipped at a tip with a wrist section fittable with an end effector. The wrist section is made up of a combination of a roll joint used to swing the end effector, a pitch joint used to tilt the end effector back and forth, and a yaw joint used to axially rotate the end effector. At least two of the turning joint, the rise/fall joint, the linear extension and retraction mechanism, the roll joint, the pitch joint, and the yaw joint are each equipped with a mechanical stopper mechanism adapted to limit motion to within a mechanical operating range and with a safety stopper mechanism adapted to limit motion to within a safe range of movement narrower than the mechanical operating range.

### BRIEF DESCRIPTION OF THE VIEWS OF THE DRAWING

FIG. 1 is a perspective view illustrating an external appearance of a robot arm mechanism according to an embodiment of the present invention;

FIG. 2 is a diagram illustrating a configuration of the robot arm mechanism of FIG. 1 using graphic symbol representation;

FIG. 3 is a plan view illustrating a structure of a stopper mechanism of a first rotary joint J1 in a column of FIG. 1:

FIG. 4 is a side view of a rise/fall section 4 of FIG. 1;

FIG. 5 is a sectional view illustrating a structure of a second rotary joint J2 in the rise/fall section of FIG. 5;

FIGS. 6A and 6B are diagrams illustrating a stopper mechanism of a second rotary joint J2 in the rise/fall section of FIG. 1;

FIG. 7 is a perspective view illustrating a stopper mechanism of a linear extension and retraction mechanism J3 of FIG. 1:

FIG. 8 is a diagram illustrating stopper mechanisms of a roll joint J4 and pitch joint J5 in a wrist section of FIG. 1; and

FIG. 9 is a diagram illustrating a stopper mechanism of a yaw joint J6 in the wrist section of FIG. 1.

### DETAILED DESCRIPTION

A robot arm mechanism according to an embodiment of the present invention is described below with reference to the drawings. The robot arm mechanism according to the present embodiment is described by taking a vertical articulated robot arm mechanism equipped with a linear extension and retraction mechanism as an example, but the robot arm may be of another type.

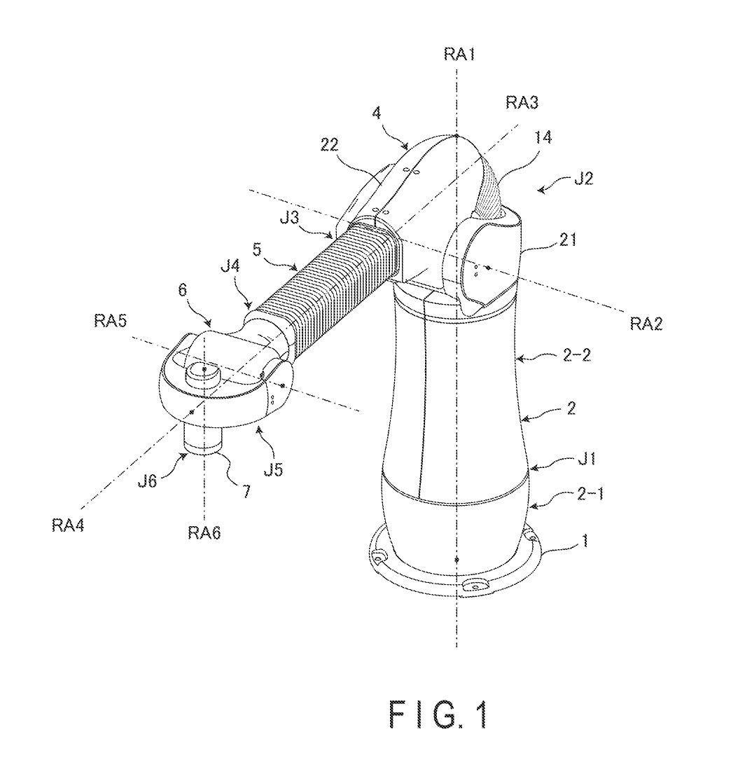

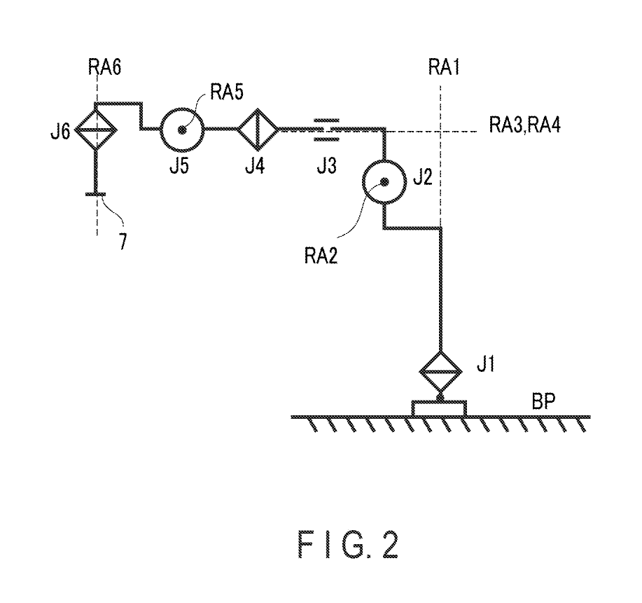

FIG. 1 illustrates an external appearance of the vertical articulated robot arm mechanism equipped with a linear extension and retraction mechanism according to the present embodiment. FIG. 2 illustrates a configuration of the robot arm mechanism using graphic symbol representation. A column 2 that forms a cylindrical body is typically installed vertically on a base stand 1 of the robot arm mechanism. The column 2 houses a first joint J1 serving as a turning joint. The first joint J1 includes a torsional rotation axis RA1. The axis of rotation RA1 is parallel to a vertical direction. As the first joint J1 rotates, an arm section 5 sweeps horizontally. The column 2 is made up of a lower part 2-1 and an upper part 2-2. The lower part 2-1 is connected to a fixed section of the first joint J1. The upper part 2-2 is connected to a rotating section of the first joint J1 and axially rotates around the axis of rotation RA1. First and second connection piece strings of a third joint J3 serving as a linear extension and retraction mechanism described later are stored in an inner space of the column 2 that forms a cylindrical body. A rise/fall section 4 adapted to house a second joint J2 serving as a rise/fall joint is installed on the upper part 2-2 of the column 2. The second joint J2 is a bending rotation joint. An axis of rotation RA2 of the second joint J2 is perpendicular to the axis of rotation RA1. The second joint J2 is placed on the upper part 2-2 of the column 2. As the second joint J2 rotates, the arm section 5 pivots up and down.

The third joint J3 is provided by a linear extension and retraction mechanism. Although details will be described later, the linear extension and retraction mechanism includes a structure newly developed by the inventors and is clearly distinguished from a so-called prismatic joint. The arm section 5 of the third joint J3 is bendable, but when the arm section 5 is sent forward along a center axis (center axis of extension and retraction RA3) from an ejection section 35 at the root, bending is limited and linear rigidity is ensured. When pulled backward, the arm section 5 recovers bendability in the ejection section 35. The arm section 5 includes a first connection piece string and second connection piece string. The first connection piece string is made up of plural first connection pieces coupled together bendably. The first connection piece is configured into a substantially flat shape. The second connection piece string is made up of plural second connection pieces. The second connection piece is a trough-like body U-shaped or channel-shaped in transverse section. The second connection pieces are bendably coupled together by connecting shafts on bottom plates. The bending of the second connection piece string is limited at a position where end faces of side plates of the second connection pieces abut each other. At this position the second connection piece string is arranged linearly. A leading first connection piece of the first connection piece string and a leading second connection piece of the second connection piece string are connected with each other by a head piece. For example, the head piece has a combined shape of the second connection piece and first connection piece.

When passing through the ejection section 35 having a rectangular cylindrical shape, the first and second connection piece strings are joined together by being pressed against each other. As a result of the joining, the first and second connection piece strings exhibit linear rigidity and makes up the arm section 5 columnar in shape. A drive gear is provided behind the ejection section 35. The drive gear is connected to a stepping motor via a speed reducer. On a back face of the first connection piece, at a center in a width direction, a linear gear is formed along a coupling direction. When the plural first connection pieces are lined up linearly, the respective linear gears are connected linearly, making up a long linear gear. The drive gear is meshed with the unified linear gear. The linearly connected linear gears make up a rack-and-pinion mechanism in conjunction with the drive gear. When the drive gear rotates forward, the first and second connection piece strings are sent forward from the ejection section 35. When the drive gear rotates backward, the first and second connection piece strings are pulled backward of the ejection section 35. When pulled back, the first and second connection piece strings are separated from each other at a location behind the ejection section. The separated first and second connection piece strings are returned to a bendable state. After returning to a bendable state, the first and second connection piece strings bend in a same direction (inward) and are stored vertically in the column 2. In so doing, the first connection piece string is stored by being almost aligned substantially parallel to the second connection piece string.

A wrist section 6 is attached to a tip of the arm section 5. The wrist section 6 is equipped with fourth to sixth joints J4 to J6. The fourth to sixth joints J4 to J6 has respective axes of rotation RA4 to RA6, which make up three orthogonal axes. The fourth joint J4 is a torsional rotation joint around the fourth axis of rotation RA4, which substantially coincides with the center axis of extension and retraction RA3, and the end effector swings along with rotation of the fourth joint J4. The fifth joint J5 is a bending rotation joint around the fifth axis of rotation RA5 placed perpendicularly to the fourth axis of rotation RA4, and the end effector tilts back and forth along with rotation of the fifth joint J5. The sixth joint J6 is a torsional rotation joint around the sixth axis of rotation RA6 placed perpendicularly to the fourth axis of rotation RA4 and fifth axis of rotation RA5, and the end effector rotates axially along with rotation of the sixth joint J6.

The end effector is attached to an adapter 7 provided in lower part of a rotating section of the sixth joint J6 of the wrist section 6. The end effector is that part of the robot which has a function to work directly on a workpiece and various tools, such as a gripper, vacuum sucker, nut fastener, welding gun, and spray gun, are available for the end effector according to tasks. According to the types of tool, the end effector is connected with various lines such as a power cable, control cable, air tube, and water-cooled cable. The end effector is moved to an arbitrary position by the first, second, and third joints J1, J2, and J3, and placed in an arbitrary posture by the fourth, fifth, and sixth joints J4, J5, and J6. In particular, length of an extension and retraction distance of the arm section 5 of the third joint J3 allows the end effector to reach an object in a wide range from a proximity position to a remote position of the base stand 1. The third joint J3 is distinguished from the conventional prismatic joint by the linear extension and retraction motion realized by the linear extension and retraction mechanism of the third joint J3 and the length of the extension and retraction distance.

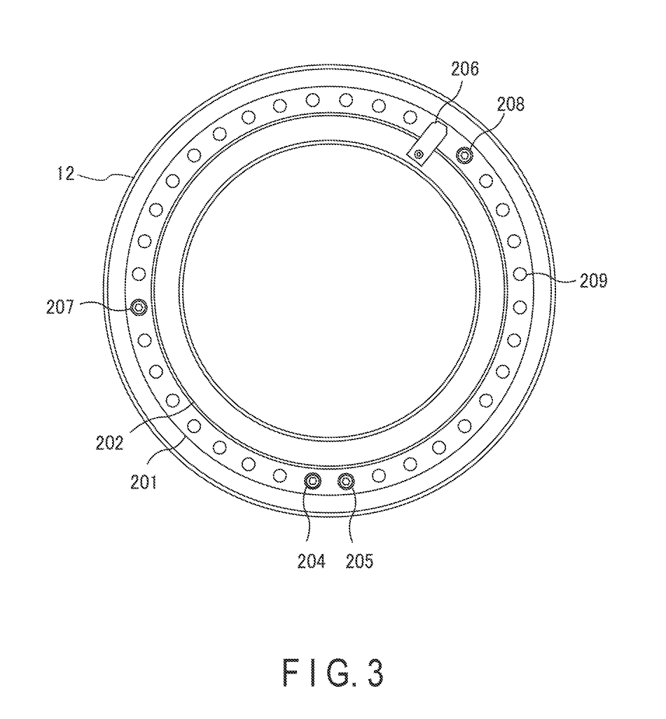

FIG. 3 is a plan view illustrating an internal structure of the first joint J1 with the upper part 2-2 of the column 2 uncovered. The first joint J1 has a rotating mount 201 cylindrical or annular in shape. The rotating mount 201 is connected to the lower part 2-1 of the column 2. Because the lower part 2-1 of the column 2 is connected to the base stand 1, the rotating mount 201 is a fixed section. A rotating body 202 has a cylindrical or annular shape. The rotating body 202 has an outside diameter slightly smaller than an inside diameter of the rotating mount 201 and is rotatably fitted inside the rotating mount 201. Typically, a bearing is intervened between the rotating mount 201 and rotating body 202. A non-illustrated column frame with, for example, a circular cylindrical shape is installed on the rotating body 202. The first and second connection piece strings, when pulled back, are stored in an inner space of the column frame. The column frame rotates axially along with rotation of the rotating body 202. The rotating body 202 is connected with a rotating shaft of a non-illustrated motor either directly or indirectly via a power transmission mechanism.

A top face of the rotating body 202 is set flush with a top face of the rotating mount 201 or slightly higher than the top face of the rotating mount 201. Stopper mechanisms are provided on the top face of the rotating body 202 and the top face of the rotating mount 201 to limit rotation of the rotating body 202. According to the present embodiment, two types of mechanical stopper mechanism are provided. The two types of stopper mechanism share part of structural components. A first of the stopper mechanisms limits the rotation of the rotating body 202 to within a mechanical operating range of the first joint J1. The mechanical operating range is a maximum permissible design rotation range of the robot in avoiding “disconnection of a large number of cables routed in the column 2” caused by the rotation of the rotating body 202, “damage caused by contact between the internal structure of the column 2 and the first and second connection piece strings,” and the like.

A second of the stopper mechanisms is provided to limit the rotation of the rotating body 202 to within a safe range of movement that varies with the surrounding environment in which the robot arm mechanism according to the present embodiment is installed. The safe range of movement is narrower than the mechanical operating range and is set arbitrarily by a user. The “safe range of movement” should be distinguished from the general term of “motion space”, which is defined as a three-dimensional region covered by a movable section of the robot. A rotation range permitted for the first joint J1 in order to secure a region (safe region) obtained by excluding a region in which the arm section 5, the wrist section 6, and even the hand device come into contact with interfering objects such as other structures and operators in an environment surrounding an installation location of the robot arm mechanism from the “range of movement” is defined herein as the “safe range of movement.”

The first stopper mechanism that restricts the operating range includes a pair of stopper blocks 204 and 205 installed on the top face of the rotating mount 201, protruding upward, and a stopper rod 206 installed on the top face of the rotating body 202, protruding radially outward. The stopper rod 206 is attached to the rotating body 202, for example, at a front position of the robot. The pair of stopper blocks 204 and 205 are installed at two limit positions of the mechanical operating range on an orbit of the stopper rod 206. The rotation of the rotating body 202 is restrained forcibly at a position where the stopper rod 206 abuts the stopper blocks 204 and 205.

The second stopper mechanism that restricts the safe range of movement includes a pair of stopper blocks 207 and 208 installed on the top face of the rotating mount 201, protruding upward, and the stopper rod 206 installed on the top face of the rotating body 202, protruding radially outward. The pair of stopper blocks 207 and 208 are installed at two limit positions of the safe range of movement on the orbit of the stopper rod 206. The stopper blocks 207 and 208 of the second stopper mechanism are installed on the same circumference as the stopper blocks 204 and 205 of the first stopper mechanism. The stopper rod 206 is shared by the two types of stopper mechanism. The rotation of the rotating body 202 is restrained at a position where the stopper rod 206 abuts the stopper blocks 207 and 208.

The stopper blocks 207 and 208 are detachably attached to block fitting sections 209 provided on the top face of the rotating mount 201. The stopper blocks 207 and 208 are, for example, hexagon socket bolts, and block fitting sections 209 are provided as screw holes. In the top face of the rotating mount 201 on the orbit of the stopper rod 206, plural block fitting sections 209 are scattered uniformly between the two stopper blocks 204 and 205 at intervals of, for example, 5 degrees. Preferably the block fitting section 209 at the front position is labeled with “0°”, and similarly, other block fitting sections 209 are labeled with “+5°”, “+10°”, . . . “−5°”, “−10°”, . . . , respectively. The stopper blocks 207 and 208 are fitted in a pair of block fitting sections 209 selected from the plural block fitting sections 209. By selecting the pair of block fitting sections 209, it is possible to respond flexibly to the safe range of movement that varies with the installation location of the robot arm mechanism.

In this way, by limiting not only the mechanical operating range, but also the safe range of movement using the mechanical stopper mechanisms, improvement of safety reliability can be expected. Also, because the state and position of fitting of the stopper blocks 207 and 208 can be visually checked, errors in setting the safe range of movement can be avoided. Furthermore, the safe range of movement can be changed easily by simply changing the fitting position of the stopper blocks 207 and 208.

Note that whereas in the above description, the stopper blocks are installed on the rotating mount and the stopper rod is installed on the rotating body, the stopper rod may be installed on the rotating mount while installing the stopper blocks on the rotating body. Also, whereas in the above description, the two stopper blocks 204 and 205 and the two stopper blocks 207 and 208 are provided, the single stopper block 204 is enough when the mechanical operating range is 360 degrees or around 360 degrees, and the single stopper block 207 is enough when the safe range of movement is needed only on one side. Also, whereas in the above description, plural block fitting sections are scattered on the orbit of the stopper rod to fit the stopper block, instead of the plural block fitting sections, an arc-shaped slit may be provided in the rotating mount 201, running from the stopper block 204 to the stopper block 205 along the orbit of the stopper rod 206. In that case, the stopper blocks 207 and 208 may be fitted in any positions of the slit without being limited by positions of block fitting sections. Furthermore, description has been given above of a structure in which the mechanical stopper mechanism used to limit the rotation of the rotating body 202 to within the mechanical operating range of the rotary joint and the mechanical stopper mechanism used to limit the rotation of the rotating body 202 to within the safe range of movement of the robot arm mechanism are provided at the same position, allowing the two types of stopper mechanism to share the stopper rod 206 fixed to the rotating body 202. However, what this means, in essence, is that the stopper mechanism used to limit the rotation of the rotating body 202 to within the safe range of movement of the robot arm mechanism is provided separately from the stopper mechanism used to limit the rotation of the rotating body 202 to within the mechanical operating range of the rotary joint. The two types of stopper mechanism may be provided at separate positions.

Note that whereas in the above description, the stopper rod 206 is attached to the rotating body 202 while the stopper blocks 204 and 205 and stopper blocks 207 and 208 are attached to the rotating mount 201, conversely the stopper blocks 204 and 205 and stopper blocks 207 and 208 may be attached to the rotating body 202 while attaching the stopper rod 206 to the rotating mount 201.

Each of the other joints J2 to J6 is similarly provided with a mechanical stopper mechanism used to limit the motion to within the mechanical operating range and a mechanical stopper mechanism used to limit the motion to within the safe range of movement narrower than the mechanical operating range.

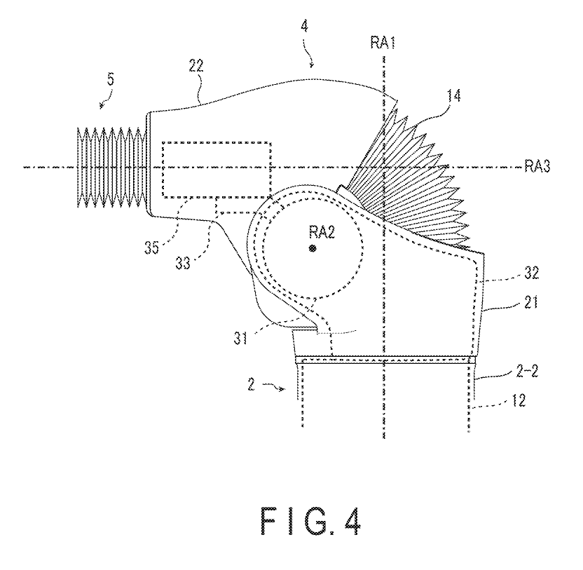

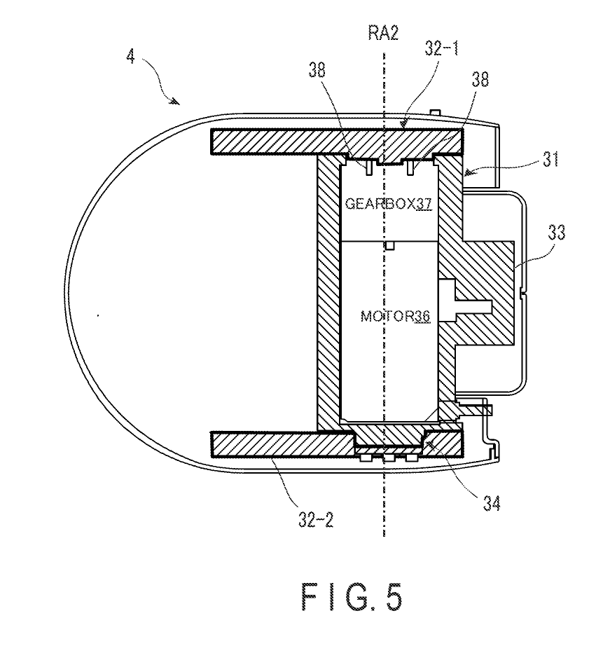

As shown in FIGS. 4 and 5, the second joint J2 includes a pair of side frames 32-1 and 32-2 as fixed sections (support sections). The side frames 32-1 and 32-2 are placed on a column frame (link) 12 as a framework for the column 2. A drum body 31 serving as a rotating section that combines a motor housing is supported by the pair of side frames 32-1 and 32-2. One end of the drum body 31 is pivotally supported by one side frame 32-2 via a bearing 34. A motor 36 is fixed inside the drum body 31 together with a gearbox 37. An output shaft (drive shaft) 38 of the gearbox 37 is fixed to the other side frame 32-1. The drum body 31 rotates along with rotation of the output shaft 38. A lug body 33 is fixed to the drum body 31, projecting forward along a radial direction from a circumferential surface of the drum body 31. The drum body 31 makes up the rotating section in conjunction with the lug body 33. The ejection section 35 adapted to support the above-mentioned first and second connection piece strings are installed on the lug body 33. When the drum body 31 rotates, the ejection section 35 rotates together with it, causing the arm section 5 supported by the ejection section 35 to pivot up and down. The first and second connection piece strings sent out through the ejection section 35 and pulled back change direction by sliding on the circumferential surface of the drum body 31. Together with the ejection section 35, the lug body 33 is covered with a hard cover 22. A gap between the hard cover 22 and a saddle-shaped hard cover 21 covering the side frames 32-1 and 32-2 is covered with a pleated cover 14.

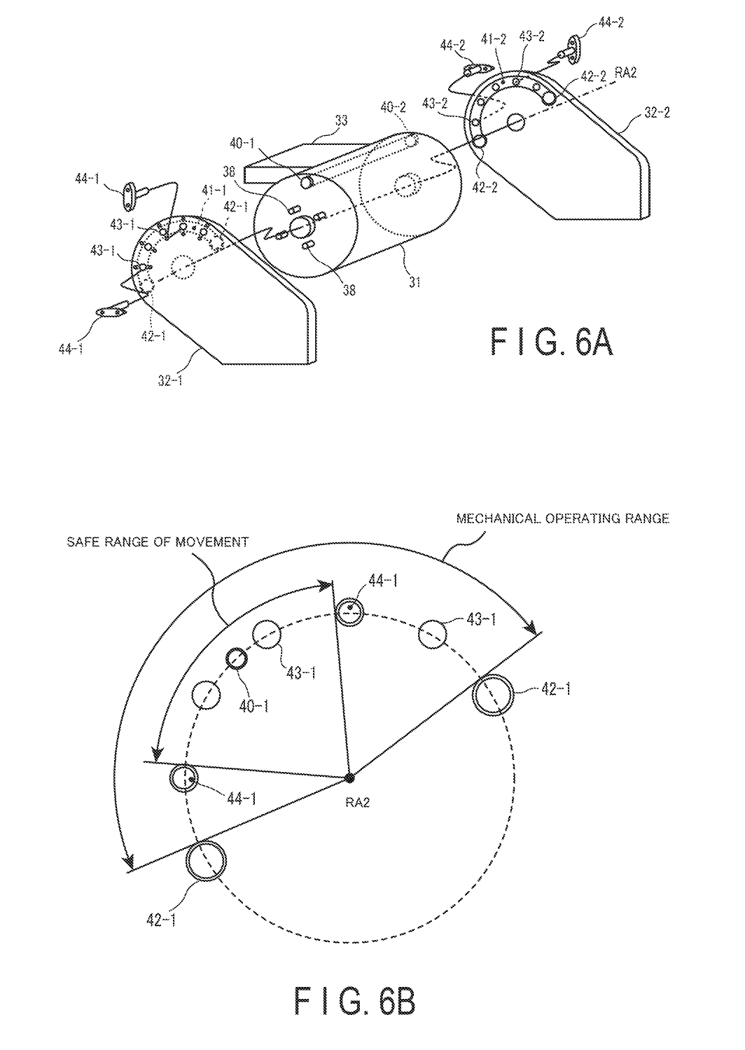

As shown in FIG. 6A, stopper rods 40-1 and 40-2 are attached to opposite ends of the drum body 31, projecting in parallel to an axial direction. Arc-shaped grooves 41-1 and 41-2 having the same radius from the axis of rotation RA2 as the stopper rods 40-1 and 40-2 are formed in inner surfaces of the side frames 32-1 and 32-2, respectively. Along with rotation of the drum body 31, the stopper rods 40-1 and 40-2 move in the arc-shaped grooves 41-1 and 41-2. Respective center angles of the grooves 41-1 and 41-2 are equivalent to the mechanical operating range of the second joint J2 regarding up-and-down pivot action of the arm section 5. Stopper blocks 42-1 are fixed to opposite ends of the groove 41-1. Stopper blocks 42-2 are similarly fixed to opposite ends of the groove 41-2. The stopper rods 40-1 and 40-2 are restrained by abutting the stopper blocks 42-1 and 42-2. Consequently, rotation of the second joint J2 is limited to within the mechanical operating range as shown in FIG. 6B.

Plural pin holes 43-1 penetrating the side frame 32-1 are formed in the groove 41-1 at equal intervals. Plural pin holes 43-2 penetrating the side frame 32-2 are also formed in the groove 41-2 at equal intervals. Stopper pins 44-1 are fitted typically into two of the plural pin holes 43-1 from outside the side frame 32-1. Similarly, stopper pins 44-2 are fitted from outside the side frame 32-2. The stopper rods 40-1 and 40-2 rotating along with rotation of the drum body 31 are restrained by abutting the stopper pins 44-1 and 44-2. Consequently, rotation of the second joint J2 is limited to within the safe range of movement. By selecting the pin holes 43-1 and 43-2 to fit the stopper pins 44-1 and 44-2 into, it is possible to arbitrarily set the safe range of movement.

Note that whereas the stopper rods 40-1 and 40-2 are attached to the drum body 31 and the grooves 41-1 and 41-2, stopper blocks 42-1 and 42-2, pin holes 43-1 and 43-2, and stopper pins 44-1 and 44-2 are provided in the side frames 32-1 and 32-2, conversely the grooves 41-1 and 41-2, stopper blocks 42-1 and 42-2, pin holes 43-1 and 43-2, and stopper pins 44-1 and 44-2 may be provided in the drum body 31 while attaching the stopper rods 40-1 and 40-2 to the side frames 32-1 and 32-2.

Also, in FIG. 6A, the stopper rods 40-1 and 40-2 are illustrated as opposite ends of a single rod penetrating the drum body 31 in parallel to the axial direction, but may be provided separately on opposite end faces of the drum body 31, protruding therefrom. Also, the mechanical stopper structure and safety stopper structure are provided at a location between one end of the drum body 31 and the side frame 32-1 and at a location between the other end of the drum body 31 and the side frame 32-2, but may be provided at either of the locations.

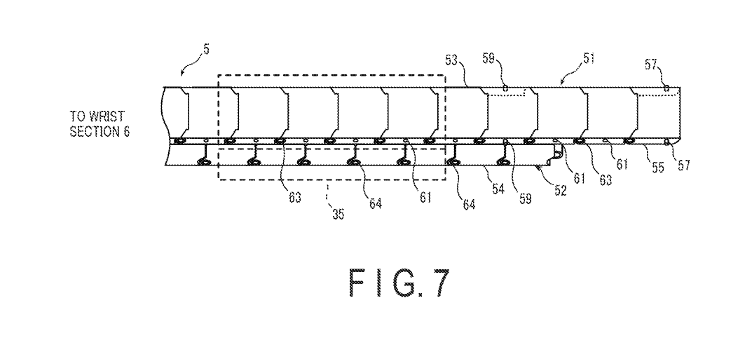

FIG. 7 illustrates a stopper mechanism of the third joint J3. Note that the left side of FIG. 7 corresponds to the front side of the arm section 5. As described above, the arm section 5 includes the first connection piece string 51 and second connection piece string 52. The first connection piece string 51 is made up of plural first connection pieces 53 shaped substantially like flat plates and coupled together bendably via connecting shafts 63. The second connection piece string 52 is made up of plural second connection pieces 54, which are each configured as a trough-like body U-shaped or channel-shaped in transverse section and are coupled together bendably via connecting shafts 64. When passing through the ejection section 35 having a rectangular cylindrical shape, the first and second connection piece strings 51 and 52 are joined together by being pressed against each other, thereby forming the column-shaped arm section 5 having linear rigidity.

To opposite sides of the rearmost first connection piece 55 of the plural first connection pieces 53 making up the first connection piece string 51, stopper pins 57 are fixed, each projecting outward. When the drive gear rotates forward, sending out the first and second connection piece strings 51 and 52 forward from the ejection section 35, and an extension distance of the first and second connection piece strings 51 and 52 reaches a limit of the mechanical operating range, the stopper pins 57 of the rearmost first connection piece 55 are restrained by abutting a rear end face of the ejection section 35.

In opposite sides of each of the plural first connection pieces 53 except the rearmost one, screw holes 61, for example, are formed as a structure for use to fit stopper pins 59. The stopper pins 59 can be fitted into the screw holes 61 in any of the first connection pieces 53. When the drive gear rotates forward, sending out the first and second connection piece strings 51 and 52 forward from the ejection section 35, and the extension distance of the first and second connection piece strings 51 and 52 reaches a limit of the safe range of movement, the stopper pins 59 of the first connection piece 53 are restrained by abutting the rear end face of the ejection section 35.

Note that whereas in the above description, the screw holes 61 and stopper pins 57 and 59 are provided on the opposite sides of the first connection piece 53, the screw holes 61 and stopper pins 57 and 59 may be provided only on one side of the first connection pieces 53. Also, the screw holes 61 and stopper pins 57 and 59 may be provided on the second connection pieces 54 rather than on the first connection pieces 53 or on both the first and second connection pieces 53 and 54.

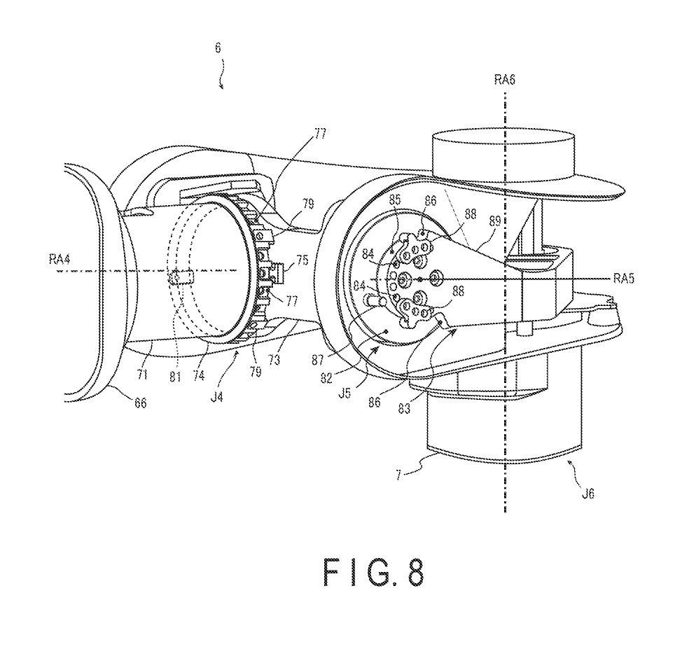

Next, a stopper mechanism of the fourth joint J4 is described. FIG. 8 illustrates an internal structure of the wrist section 6. A cylindrical shaft body 71 is fixed to a mount 66 at the tip of the arm section 5, and a rectangular rotating body 73 is fitted over the cylindrical shaft body 71 rotatably around the axis of rotation RA4. The cylindrical shaft body 71 makes up the fourth joint J4 in conjunction with the rotating body 73. Plural stopper piece fitting sections 77 are arranged in the shape of an arc in a flange 74 of the cylindrical shaft body 71 along its circumference. The stopper piece fitting sections 77 are provided, for example, as rectangular recesses. A stopper piece 81 is fixed to a specific stopper piece fitting section 77. A stopper block 75 is attached to the rotating body 73. A tip portion of the stopper piece 81 projects forward from the flange 74 by being located on an orbit of the stopper block 75. Note that the stopper piece 81 may be detachable from the flange 74 or may be provided integrally with the flange 74, for example, in such a way as to unremovably extend from the flange 74.

When the rotating body 73 rotates and the rotation angle reaches a limit of the mechanical operating range, the stopper block 75 is restrained by abutting the stopper piece 81. Note that the stopper block 75 is formed, for example, into an H-shape. The stopper piece 81 is fitted into a recessed portion of the H-shaped stopper block 75. The H-shape of the stopper block 75 can extend a limited range by a distance equivalent to depth of a depression in the H-shape while ensuring mounting strength of the H-shaped stopper block 75 on the rotating body 73.

Stopper pieces 79 can be fitted into any of the stopper piece fitting sections 77. When the rotating body 73 rotates and the rotation angle reaches a limit of the safe range of movement, the stopper block 75 is restrained by abutting the stopper piece 79.

Note that whereas in the above description, the stopper piece fitting sections 77, stopper pieces 79, and stopper piece 81 are provided on the flange 74 of the shaft body 71 while attaching the stopper block 75 to the rotating body 73, conversely the stopper piece fitting sections 77, stopper pieces 79, and stopper piece 81 may be provided on the rotating body 73 while attaching the stopper block 75 to the flange 74 of the shaft body 71.

Next, a stopper mechanism of the joint J5 is described. A U-shaped arm 83 is supported at opposite ends by the rotating body 73 rotatably around the fifth axis of rotation RA5. The U-shaped arm 83 makes up the fifth joint J5 in conjunction with the rotating body 73. An end portion 85 of the U-shaped arm 83 pivotally supported by the rotating body 73 is disk-shaped, an arm portion 89 is wider than the disk-shaped portion 85, and thus an end face 86 of the arm portion 89 projects in a radial direction from an outer circumference of the disk-shaped portion 85. To an end portion 82 of the rotating body 73, a stopper pin 87 is fixed at a specific position close to the outer circumference of the disk-shaped portion 85. When the U-shaped arm 83 rotates and the rotation angle reaches a limit of the mechanical operating range, the end face (stopper) 86 of the arm portion 89 is restrained by abutting the stopper pin 87. Note that the mechanical stopper structure and safety stopper structure of the fifth joint J5 are provided at a location between one end of the rotating body 73 and one end of the U-shaped arm 83 and at a location between the other end of the rotating body 73 and the other end of the U-shaped arm 83, but may be provided at one of the locations.

In the disk-shaped portion 85, plural stopper piece fitting sections 84 are arranged in the shape of an arc along a circumference of the disk-shaped portion 85. Stopper pieces 88 can be fitted over any of the stopper piece fitting sections 84. The stopper pieces 88 provide, for example, screw holes. When the U-shaped arm 83 rotates and the rotation angle reaches a limit of the safe range of movement, the stopper piece 88 is restrained by abutting the stopper pin 87.

Note that whereas in the above description, the stopper pin 87 is attached to the rotating body 73, the stopper 86 is provided on the U-shaped arm 83, and the stopper pieces 88 are provided on the stopper piece fitting sections 84, conversely the stopper pin 87 may be attached to the U-shaped arm 83 while providing the stopper 86, stopper piece fitting sections 84, and stopper pieces 88 on the rotating body 73.

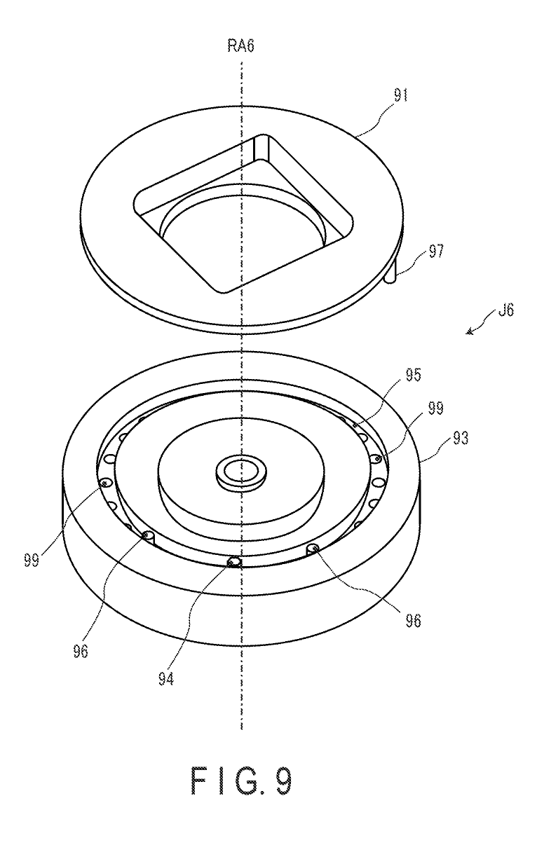

Next, a stopper mechanism of the sixth joint J6 is described. As shown in FIG. 9, the sixth joint J6 includes an annular fixed section 91 fixed to a center of the U-shaped arm 83, and a disk-shaped rotating body 93 rotatably supported on the fixed section 91. A stopper rod 97 is attached to the fixed section 91. An annular groove 95 is provided in the rotating body 93. When the rotating body 93 rotates, the stopper rod 97 moves in the groove 95 in a relative way. A stopper pin 94 is fixed at a specific position in the groove 95. When the rotating body 93 rotates and the rotation angle reaches a limit of the mechanical operating range, the stopper pin 94 is restrained by abutting the stopper rod 97.

Plural stopper pin fitting sections 99 are arranged in the groove 95 along its circumference. Stopper pins 96 can be fitted into any of the stopper pin fitting sections 99. The stopper pins 96 are provided, for example, as screw holes. When the rotating body 93 rotates and the rotation angle reaches a limit of the safe range of movement, the stopper pin 96 is restrained by abutting the stopper rod 97.

Note that whereas in the above description, the stopper rod 97 is attached to the fixed section 91 and the groove 95, stopper pin 94, stopper pin fitting sections 99, and stopper pin 96 are provided in the rotating body 93, conversely the stopper rod 97 may be attached to the rotating body 93 while providing the groove 95, stopper pin 94, stopper pin fitting sections 99, and stopper pin 96 on the fixed section 91.

In this way according to the present embodiment, all the joints are equipped with the stopper mechanisms adapted to limit respective motions to the respective mechanical operating ranges as well as with the stopper mechanisms adapted to limit respective motions to the respective safe ranges of movement, thereby making it possible to effectively restrict three-dimensional movements of the end effector or arm section 5 and thus improve safety reliability while allowing the arm section 5 and the like to operate to the fullest extent.

Note that the operation and effect can be achieved to some extent by providing respective mechanical stopper mechanisms adapted to limit motions to within the mechanical operating ranges and respective safety stopper mechanisms adapted to limit motions to within the safe ranges of movement narrower than the mechanical operating ranges on at least two of the turning joint J1, rise/fall joint J2, linear extension and retraction mechanism J3, roll joint J4, pitch joint J5, and yaw joint J6, on at least two of the turning joint J1, rise/fall joint J2, and linear extension and retraction mechanism J3, or on at least two of the roll joint J4, pitch joint J5, and yaw joint J6.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 . . . base stand, 2 . . . column, 4 . . . rise/fall section, 5 . . . arm section, 6 . . . wrist section, 201 . . . rotating mount, 202 . . . rotating body, 204, 205 . . . stopper block, 206 . . . stopper rod. 207, 208 . . . stopper block, 209 . . . block fitting section

1. A robot arm mechanism, in which a column equipped with a turning joint is supported on a base stand, a rise/fall section equipped with a rise/fall joint is placed on the column, a linear extension and retraction mechanism equipped with a linearly extendible and retractable arm is provided on the rise/fall section, the arm is equipped at a tip with a wrist section fittable with an end effector, and the wrist section is made up of a combination of a roll joint used to swing the end effector, a pitch joint used to tilt the end effector back and forth, and a yaw joint used to axially rotate the end effector, wherein
at least two of the turning joint, the rise/fall joint, the linear extension and retraction mechanism, the roll joint, the pitch joint, and the yaw joint are each equipped with a mechanical stopper mechanism adapted to limit motion to within a mechanical operating range and with a safety stopper mechanism adapted to limit motion to within a safe range of movement narrower than the mechanical operating range.

2. The robot arm mechanism according to claim 1, wherein at least two of the turning joint, the rise/fall joint, and the linear extension and retraction mechanism are each equipped with the mechanical stopper mechanism and the safety stopper mechanism.

3. The robot arm mechanism according to claim 2, wherein each of the turning joint, the rise/fall joint, and the linear extension and retraction mechanism is equipped with the mechanical stopper mechanism and the safety stopper mechanism.

4. The robot arm mechanism according to claim 2, wherein each of the turning joint and the rise/fall joint is equipped with the mechanical stopper mechanism and the safety stopper mechanism.

5. The robot arm mechanism according to claim 2, wherein each of the turning joint and the linear extension and retraction mechanism is equipped with the mechanical stopper mechanism and the safety stopper mechanism.

6. The robot arm mechanism according to claim 2, wherein each of the rise/fall joint and the linear extension and retraction mechanism is equipped with the mechanical stopper mechanism and the safety stopper mechanism.

7. The robot arm mechanism according to claim 1, wherein at least two of the roll joint, the pitch joint, and the yaw joint are each equipped with a stopper mechanism adapted to limit motion to within a mechanical operating range and with a stopper mechanism adapted to limit motion to within a safe range of movement narrower than the mechanical operating range.

8. The robot arm mechanism according to claim 7, wherein each of the roll joint and the pitch joint is equipped with a stopper mechanism adapted to limit motion to within a mechanical operating range and with a stopper mechanism adapted to limit motion to within a safe range of movement narrower than the mechanical operating range.

9. The robot arm mechanism according to claim 7, wherein each of the roll joint and the yaw joint is equipped with a stopper mechanism adapted to limit motion to within a mechanical operating range and with a stopper mechanism adapted to limit motion to within a safe range of movement narrower than the mechanical operating range.

10. The robot arm mechanism according to claim 7, wherein each of the pitch joint and the yaw joint is equipped with a stopper mechanism adapted to limit motion to within a mechanical operating range and with a stopper mechanism adapted to limit motion to within a safe range of movement narrower than the mechanical operating range.
